(19) United States
(12) Patent Application Publication
(10) Pub. No.: US 2011/0071677 A1
(43) Pub. Date: Mar. 24, 2011

(54) FORCE BALANCING MOBILE ROBOTIC SYSTEM

(75) Inventor: Michael Stilman, Atlanta, GA (US)

(73) Assignee: Georgia Tech Research Corporation, Atlanta, GA (US)

(21) Appl. No.: 12/993,650

(22) PCT Filed: May 21, 2009
(86) PCT No.: PCT/US09/44902

§ 371 Date: Nov. 19, 2010

Related U.S. Application Data
(60) Provisional application No. 61/054,903, filed on May 21, 2008.

(51) Int. Cl. G05B 19/04

(52) U.S. Cl. 700/254

(57) ABSTRACT

A force balancing robotic system and related methods are disclosed. The robotic system can include a body, a balancing member, and a balancing system. The robotic system can be statically unstable, which can be a result of having a statically unstable body. The balancing member can be connected to the body by a joint. The balancing system can have one or more sub-systems utilized to dynamically balance the robotic system. Such subsystems can include a repositioning system, an accelerating system, and a driving system. The repositioning system can reposition the balancing members to position the center of mass over a target. The accelerating system can accelerate the balancing members to produce a target torque. The driving system can drive the wheels of the robotic system to maintain balance. While retaining balance, the robotic system can absorb external force and apply forces to external objects.

### CROSS-REFERENCE TO RELATED APPLICATIONS

This application claims a benefit, under 35 U.S.C. §119(e), of U.S. Provisional Application Ser. No. 61/054,903, filed 21 May 2008, the entire contents and substance of which are hereby incorporated by reference.

### TECHNICAL FIELD

Various embodiments of the present invention relate to mobile assets and, more particularly, to force balancing mobile robots useable for object transportation and manipulation.

### BACKGROUND

Most existing transport systems achieve positioning of humans or loads through static stability. In other words, such systems are mechanically structurally stable with regard to all foreseen conditions of placement for their ground contacts. For example, automobiles and tricycles maintain their center of gravity over the polygon formed by their wheels. They maintain their positions without any actuation additional to that required to maintain their velocities.

A drawback to statically stable systems is that they generally require multiple contact points with the ground or, alternatively, a large ground contact surface to maintain static balance. As a result, such devices are impractical for use on rugged or cluttered terrains.

Existing dynamically stable systems solve this problem of statically stable systems but present an additional problem. Dynamically stable systems are systems that, although not necessarily stable while at rest, can be made stable by active movement of the system. For example, dynamically stable systems include those described in U.S. Pat. Nos. 5,971,091, 6,915,878, and 7,082,350. Because static stability is not a requirement of such systems, dynamically stable systems generally have fewer, or smaller, contact points than do statically stable systems. As a result, some dynamically stable systems are useable when a smaller ground surface is available for operation of the system.

A drawback of such dynamically stable systems is that the ground-contacting surfaces are permitted to move arbitrarily to maintain balance. For example, wheels of the dynamically stable systems in the above-listed patents are permitted to continuously move back and forth to maintain balance. Therefore, these systems may be unsafe for use in direct contact with humans and may also require an arbitrarily large ground surface on which to operate.

### SUMMARY

There is a need for a mobile self-balancing robotic system useable on a rugged or cluttered terrain. In an exemplary embodiment, such a robotic system can be dynamically stable while maintaining an approximately constant velocity across a surface. Additionally, it is desirable that the robotic system maintain its balance while absorbing, as well as applying forces. It is to such a robotic system that embodiments of the present invention are directed.

Embodiments of the invention can include robotic systems methods for controlling same. An exemplary embodiment of such a robotic system can include a body, a ground-contacting assembly, at least two balancing members, and a balancing system.

The body can act as a structural foundation for the robotic system. The body can be statically unstable and, as a result, the entire robotic system can be statically unstable. The balancing system is provided to dynamically stabilize the body and robotic system as a whole. Additionally the body can house various equipment, such as components of the balancing system, for operation of the robotic system.

The ground-contacting assembly can support the body over a surface, such as the ground. In an exemplary embodiment, the ground-contacting assembly contacts the ground at one or more small contact areas. Small contact areas can enable the robotic assembly to effectively operate on a small, cluttered, or uneven surface. As a result of such small contact areas, however, as described above, the body can be statically unstable. For example, the ground-contacting assembly can comprise two wheels axially-aligned wheels. Without an active balancing system, the body would fall over when supported by just two wheels.

One or more balancing members can enable dynamic stabilization of the robotic system. In an exemplary embodiment, the balancing members are arranged in a chain to form an articulated arm. In the arm, the balancing members can be connected together by joints, and each joint can be coupled to an actuator. The positions of the balancing members relative to body can be easily determined because the orientations of the joints are known.

The balancing system can have one or more sub-systems utilized to keep the robotic system balanced in the face of forces absorbed and applied by the robotic system. Such subsystems can comprise a repositioning system, an accelerating system, and a driving system. The repositioning system and the accelerating system can manipulate the balancing members to keep the body balanced. More specifically, the repositioning system can reposition the balancing members to reposition the center of mass. The accelerating system can accelerate the balancing members to produce torque effective to balance the body. In contrast, the driving system can drive the wheels of the robotic system to maintain balance. Each of such sub-systems of the balancing system can be used independently to balance the robotic system, or alternatively, the sub-systems can be used in coordination with one another to provide balance customized for a specific use of the robotic system.

These and other objects, features, and advantages of the robotic systems and methods will become more apparent upon reading the following specification in conjunction with the accompanying drawing figures.

### BRIEF DESCRIPTION OF THE FIGURES

FIG. 1 illustrates a robotic system, according to an exemplary embodiment of the present invention.

FIG. 2 illustrates the robotic system supporting a payload in a fixed position, according to an exemplary embodiment of the present invention.

FIG. 3 illustrates the robotic system having parallel chains for balancing members and the payload, according to an exemplary embodiment of the present invention.

FIG. 4 illustrates the robotic system having multiple chains of balancing members balancing the payload, according to an exemplary embodiment of the present invention.

FIG. 5A illustrates the robotic system supporting the payload on an articulated arm, according to an exemplary embodiment of the present invention.

FIG. 5B illustrates the robotic system supporting the payload on an articulated arm arranged in a closed loop, according to an exemplary embodiment of the present invention.

FIG. 6 illustrates a block diagram of various hardware components of the robotic system, according to exemplary embodiments of the present invention.

FIGS. 7A-7B illustrate an effect of a repositioning system of the robotic system, according to an exemplary embodiment of the present invention.

FIG. 8 illustrates a method of operation of the reposition system, according to an exemplary embodiment of the present invention.

FIG. 9 illustrates an operation of an accelerating system of the robotic system, according to an exemplary embodiment of the present invention.

FIG. 10 illustrates a method of operation of a driving system of the robotic system, according to an exemplary embodiment of the present invention.

### DETAILED DESCRIPTION

To facilitate an understanding of the principles and features of the present invention, various illustrative embodiments are explained below. Exemplary embodiments of the invention comprise robotic systems and methods for controlling and dynamically balancing such systems. In particular, embodiments of the robotic systems are described in the context of use for transportation and manipulation of objects. Embodiments of the invention, however, are not limited to this context. Rather, various embodiments of the invention can be used in various other contexts. For example, while maintaining balance, various embodiments can apply forces to external objects, or can maintain placement of an object in the face of external forces. Various embodiments can also be used in context Additionally, although the robotic system depicted in the drawing figures herein has some physical human characteristics, this is not required of a robotic system according to the present invention. For example, in some embodiments, the robotic system can have the physical appearance of a mobile vehicle or other mobile asset.

The components described hereinafter as making up various elements of the invention are intended to be illustrative and not restrictive. Many suitable components that would perform the same or similar functions as components described herein are intended to be embraced within the scope of the robotic systems and methods. Such other components not described herein may include, but are not limited to, for example, components developed after development of the invention.

Referring now to the figures, wherein like reference numerals represent like parts throughout the views, various embodiments of the robotic systems and methods will be described in detail.

### I. OVERVIEW OF THE ROBOTIC SYSTEM

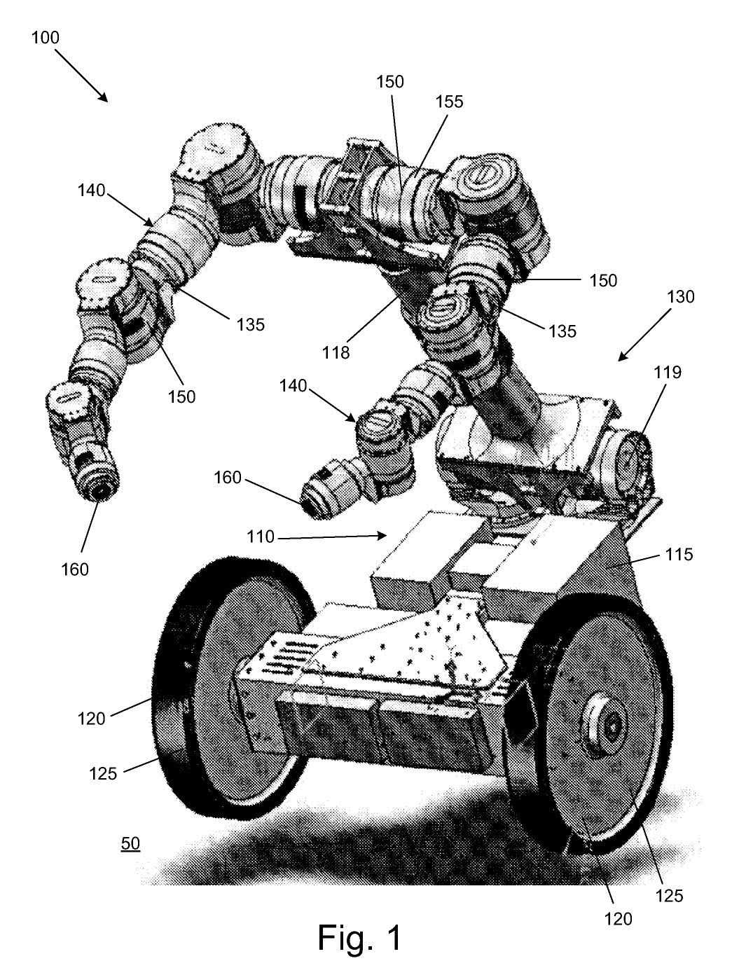

FIG. 1 illustrates an exemplary embodiment of the robotic system 100. As shown in FIG. 1, the robotic system 100 can include a body 110, a ground-contacting assembly 120, one or more balancing members 135, and a balancing system 130. The body 110 can provide a structural foundation for the robotic system 100. The ground-contacting assembly 120 can support the body 110 over a surface 50, such as the ground. The balancing members 135 can provide various functions, such as supporting a payload or contributing to dynamic stabilization of the robotic system 100. Such dynamic stabilization will be described in detail below.

The robotic system 100 is considered to be in equilibrium when all forces acting on the robotic system 100 balance. In the simplest static case the torques acting on the robotic system 100 result from gravitational forces acting on the masses of the robotic system 100. Therefore, equilibrium is generally achieved when the center of mass of the robotic system 100 lies on a target line, which extends vertically through a target point. The target point is the point on a surface 50, such as the ground, wherein the robotic system 100 is balanced when the center of mass of the robotic system 100 is positioned over the target point. For example, when the robotic system 100 has a zero speed over a flat surface 50, the target point is a central point between the points at which the robotic system 100 contacts the surface 50. In the case of a two-wheeled robotic system 100 on a flat surface 50, such target point is a center position between the contact points of the two wheels.

Through the balancing system 130, the robotic system 100 seeks to restore at equilibrium by balancing it various components. The robotic system 100 need not be statically stable. In other words, given a fixed state of the components of the robotic system 100, the robotic system 100 will generally not remain at equilibrium under an external force, such as an environment disturbance. Typically, the robotic system 100 will lose balance, thereby changing its attitude, height, or pitch. In some instances, remaining in such a fixed state under the external force will cause the robotic system 100 to fall over.

Although not statically stable, the robotic system 100 can be dynamically stable. In other words, by actively changing its state, the robotic system 100 can retain its balance when an external force is applied. Further, some embodiments of the robotic system 100 can return a payload to a target position of the payload while the robotic system 100 continuously balances itself.

In general, the robotic system 100 can remain balanced by continuously seeking to “stabilize” the center of mass. As used herein, the term “stable center of mass” refers to a center of mass that is positioned such that the overall robotic system 100 is balanced, or stabilized. Other systems and devices that seek to stabilize the center of mass do so by constantly leaning the device over a target point. The target point is the point on the surface 50, wherein the center of mass is stabilized when placed over the target point. Generally, the target point is a position central to the contact points of a ground-contacting assembly 120, such as between a set of wheels 125. A difficulty of other devices, however, is that, as the device leans, a base of the device moves, thereby dynamically changing the target point. As a result, such other devices often oscillate back and forth to remain balanced.

In contrast, embodiments of the robotic system 100 can apply hard constraints of movement on the ground-contacting assembly 120 to maintain balance. A three-dimensional volume of “operational points” can be provided for the robotic system 100 given any fixed location of the ground-contacting assembly 120. An operational point can be a target position of a payload or, alternatively, a point at which a force is to be applied, such as the contact point of a drill or screwdriver.

The robotic system 100 can achieve volumes of operational points, as well as limits on displacement of the ground-contacting assembly 120, through actuated motion or positioning of the balancing members 135. As a result, the center of mass of the robotic system 100 can be fully or partially decoupled from the position of the operational point. This yields a volume of operational points for a given target point. Additionally, the balancing system 130 can enable the robotic system 100 to absorb one or more external forces, and can restore the operational point while constraining displacement of the ground-contacting assembly 120.

As a result, the robotic system 100 can be applicable to line, point, or continuously changing surfaces 50. The robotic system 100 can balance and satisfy continuous changes to constraints on surface contacts and payload positioning. Furthermore, because the robotic system 100 device can have a flexible mechanical structure, the robotic system 100 can be adapted to specific engineering constraints.

### II. COMPONENTS OF THE ROBOTIC SYSTEM

As mentioned above, and as illustrated in FIG. 1, the robotic system 100 can include a body 110, a ground-contacting assembly 120, one or more balancing members 135, and a balancing system 130.

In an exemplary embodiment, various components of the robotic system 100, such as the body 110 and the balancing members 135, are composed of rigid, sturdy materials, such as steel, aluminum, or a strong polymer.

A. The Body

The body 110 can be a structural foundation for the robotic system 100. The body 110 can be statically unstable, thereby causing the entire robotic system 100 to be statically unstable. Stability refers to the system's asymptotic behavior of returning to an operational point or orientation. In other words, in the absence of active balancing of the robotic system 100, the statically unstable body 110 can be incapable of remaining upright. Because the robotic system 100 can be actively self-balancing, however, the body 110 can be dynamically stabilized.

The body 110 can also house various equipment utilized in operation of a balancing system 130 of the robotic system 100. As will be described in detail below, the balancing system 130 can maintain the robotic system 100 in a balanced state.

In some exemplary embodiments, the body 110 can comprise a base 115 and an optional torso 118. If provided, the torso 118 can extend generally upwardly from the base 115. One or more of the balancing members 135 can extend from the torso 118, as shown in FIG. 1. The base 115 and the torso 118 can be attached to each other by an actuated waist joint 119, which can be controllable by a motor.

B. The Ground-Contacting Assembly

Referring back to FIG. 1, the ground-contacting assembly 120 can support the body 110 on a surface 50, such as the ground. For example, the ground-contacting assembly 120 can comprise one or more wheels 125. In an exemplary embodiment, the ground-contacting assembly 120 has a relatively small contact area with the ground 50. Therefore, only a correspondingly small surface area of the ground 50 is required for operation of the robotic system 100. As illustrated in FIG. 1, in an exemplary embodiment, the ground-contacting assembly 120 can comprise no more than two wheels 125. The wheels 125 can be axially aligned. As supported by such a ground-contacting assembly 120, the robotic system 100 can be statically unstable.

Although the robotic assembly 100 is described herein as being supported on two axially-aligned wheels 125, this is not required of all embodiments of the robotic system 100. For example, the robotic system 100 can be supported on one wheel or a large roller. Alternatively, the robotic system 100 can be statically stable and supported, for example, on three or four wheels. In that case, the balancing system 130 can still be utilized to stabilize the robotic system 100 is it becomes unstable, such as by navigating rough terrain.

A robotic system 100 according to embodiments of the present invention can be operable where the contact area between the robotic system 100 and the ground 50 is limited or irregular. For example, the robotic system 100 can be useful in hazardous mine zones, demolished or unstable buildings, and other conditions requiring minimal ground contact and accurate positioning of sensors, tools, and detectors. Additionally, the robotic system 100 can provide increased stability over other devices for transporting objects at high speeds, over uneven terrain, and in the presence of accelerating forces, such as gravity, centripetal force, and water waves.

Other important applications can include factory automation, where programmable manipulation tasks require transport and assembly of mechanical components in a limited workspace. In hospital automation, the robotic system 100 can monitor patient physical activity and provide physical support and transport for humans with limited mobility.

Such applications can be made possible by the small required ground contact area of the robotic system 100, as well as effective balancing and stabilization provided by the balancing system 130, as described in detail below.

C. The Balancing Members

One or more balancing members 135 can be provided for various purposes, including contributing to the balance of the robotic system 100. As illustrated in FIG. 1, the balancing members 135 can be serially arranged in an articulated arm 140. This configuration is space efficient and can provide sufficient degrees of freedom in the balancing members 135 to enable balancing the robotic system 100 through either reposition or accelerating the balancing members 135.

One or more articulated arms 140 can extend from the body 110. As shown in FIG. 1, an exemplary embodiment of the robotic system 100 can have two articulated arms 140, but this is not required. In the articulated arm 140, each balancing member 135 can be connected to an adjacent balancing member 135 by an actuated joint 150. An additional actuated joint 150, a shoulder joint 155, can attach the articulated arm 140 to the body 110. The joints 150 can position each balancing member 135 at a determined position relative to an adjacent balancing member 135. Each joint 150 can provide at least one, and up to six degrees of freedom for adjacent balancing members 135. Additionally, each joint 150 can be controllable by a motor or other actuator.

An articulated arm 140 can serve various purposes, including, for example, providing balance to the robotic system 100 and supporting a payload. One or more force sensors 160 can be provided to detect forces exerted on the robotic system 100. Such a force sensor 160 can be provided at, or near, the terminus of one or more of the articulated arms 140. The force sensor 160 can detect a force applied to the robotic system 100 by the payload or other environmental factor. Accordingly, the robotic system 100 can change its state, or configuration, to balance or counteract applied forces. In the case of a payload 200, the detected force can be used in determining how to balance the payload 200.

A payload can be many external objects supportable by the robotic system 100, such as a human, device, or other object. When the robotic system 100 carries a payload, the payload exerts an external force on the robotic system 100 and can change the center of mass of the robotic system 100. Accordingly, the balancing system 130 of the robotic system 100 will need to restore balance to the robotic system 100, such as by repositioning the balancing members 135.

In addition to arrangement into two distinct articulated arms 140, various alternative arrangements can be provided for the balancing members 135. An arrangement for a particular build of the robotic system 100 can be selected so as to balance a payload, or withstand an external steady-state force, according to specifications of an engineer or other user.

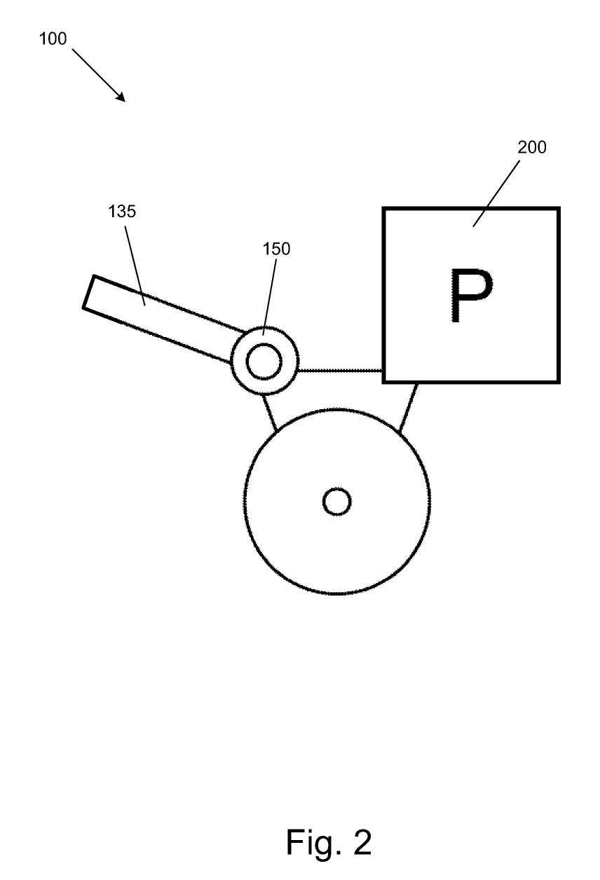

FIG. 2 illustrates a robotic system 100 for supporting the payload 200 in a fixed position. In such an embodiment, the balancing members 135 can be arranged so as to balance the payload 200 along with any external forces acting on the robotic system 100 and forces applied by the robotic system 100. The balancing members 135 can be moveable so as to balance the payload 200 as the robotic system 100 moves and external forces are applied.

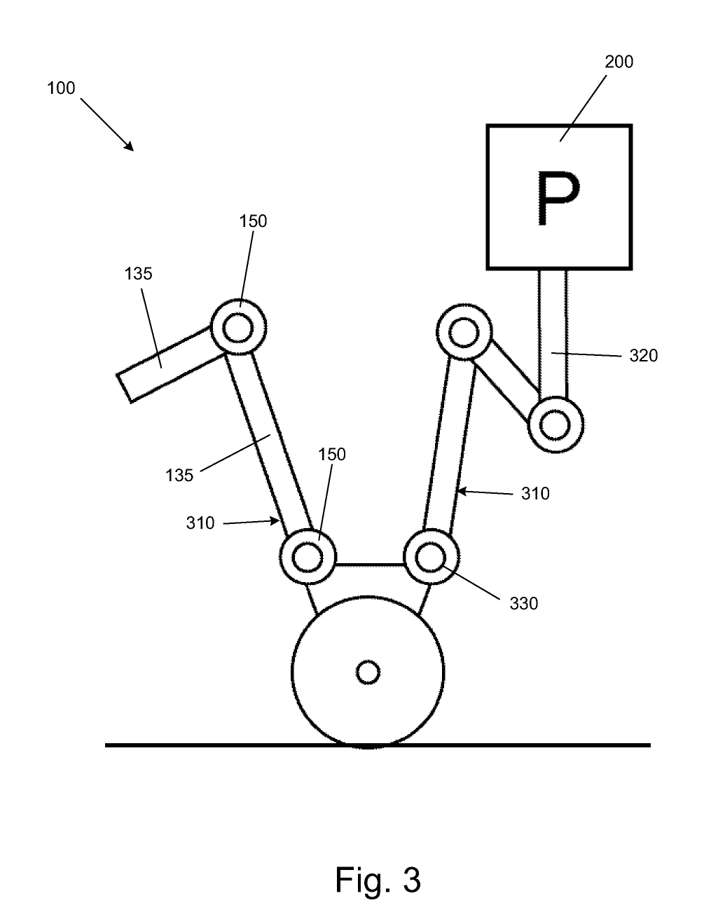

FIG. 3 illustrates an embodiment of the robotic system 100, in which the payload 200 and the balancing members 135 are components of parallel chains 310. In a first chain 310, a payload support 320 can support the payload 200. The payload support 320 can be attached to the body 110 by an actuated payload joint 330 and can extend the payload 200 away from the body 110. The payload joint 330 can be controllable by various types of actuators, such as a motor. In the second chain 310, the balancing members 135 can balance the payload 200 with the rest of the robotic system 100. Such balancing can comprise targeted movement and repositioning of the balancing members 135.

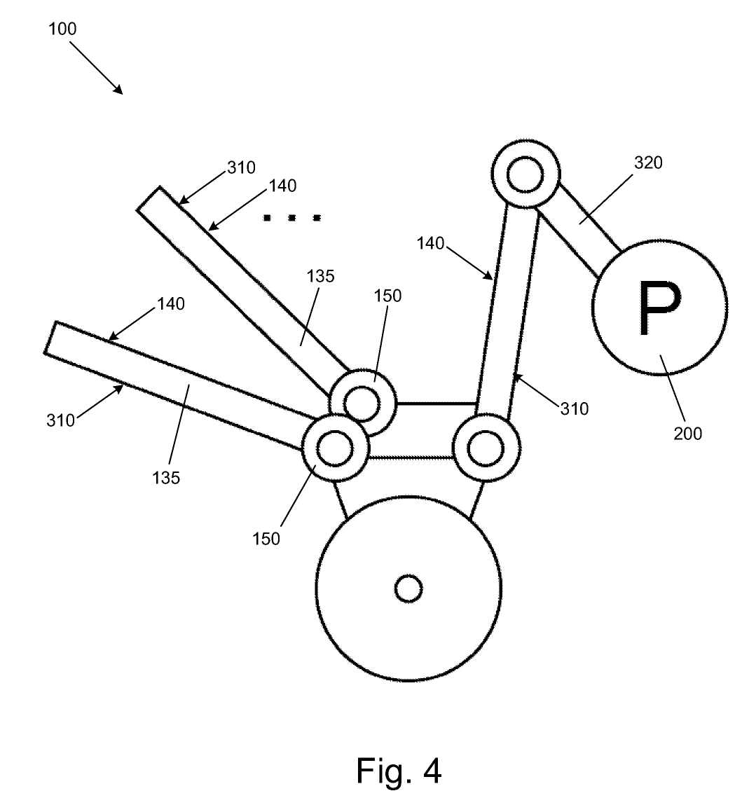

FIG. 4 illustrates yet another embodiment of the robotic system 100 supporting a payload 200. In this embodiment, the balancing members 135 can be arranged into multiple chains 310, such as articulated arms 140, parallel to the payload 200. Additionally, the payload 200 can be positioned on an articulated arm 140, as shown. Compared to the robotic system 100 of FIG. 3, this embodiment of the robotic system 100 can provide an increased quantity of balancing configurations.

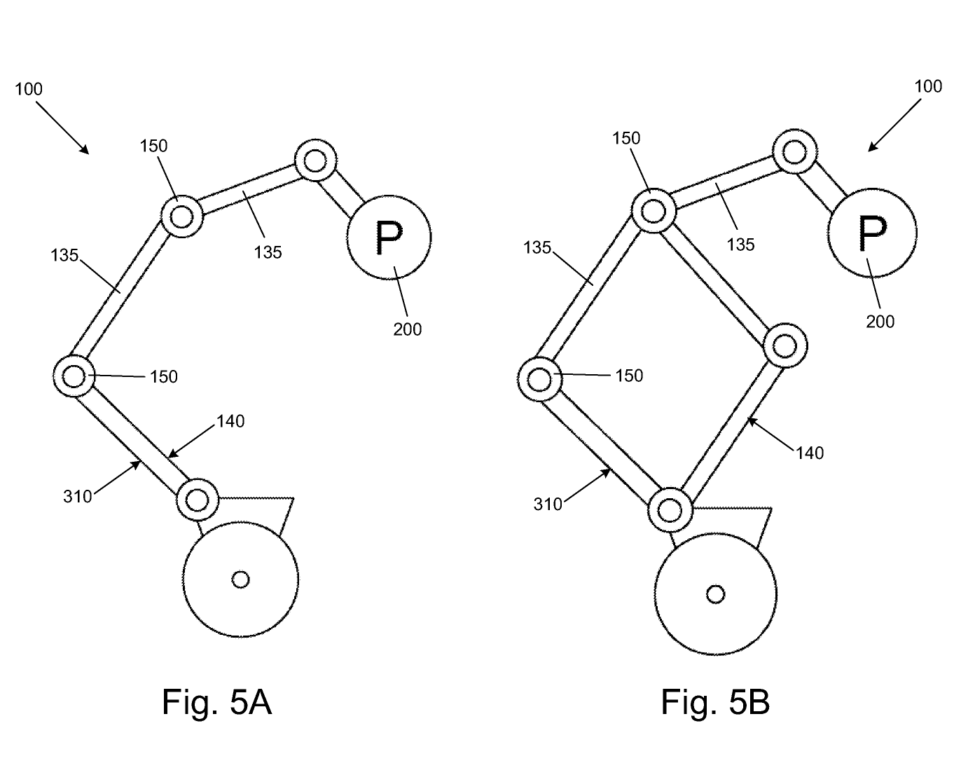

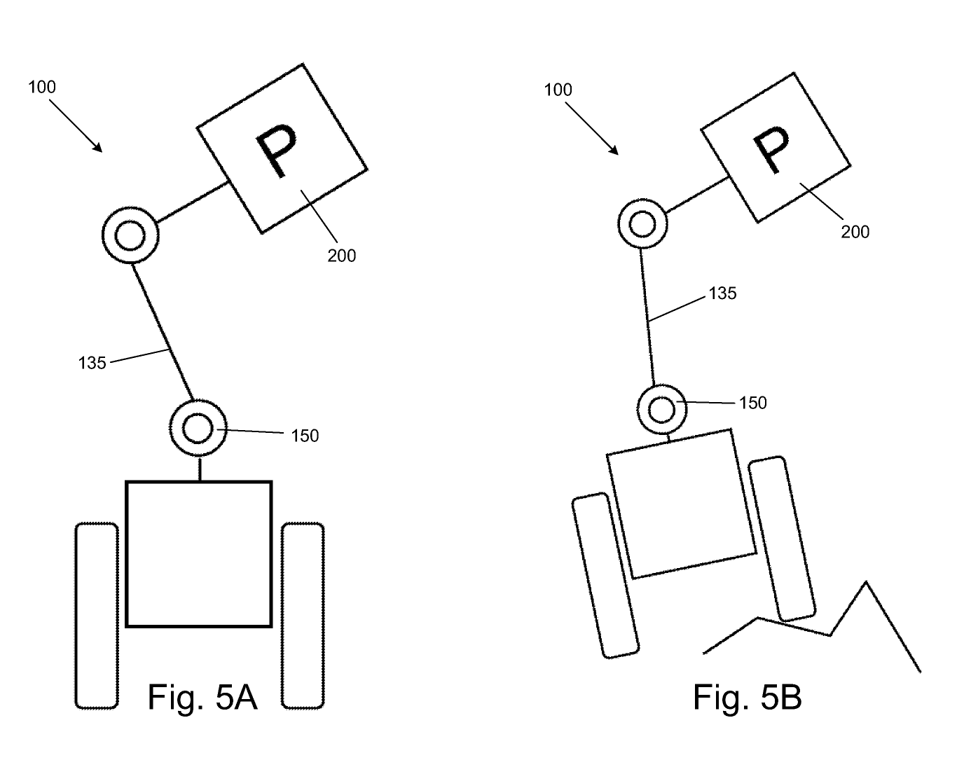

Further alternatively, as illustrated in FIGS. 5A-5B, the payload 200 can be supported by an articulated arm 140. As shown, the payload 200 can be positioned at, or proximate, the terminus of the articulated arm 140. Alternatively, although not shown, the payload 200 can be supported by an intermediate portion of the articulated arm 140.

Additionally, as illustrated in FIG. 5B, the balancing members 135 can form a closed loop 510. The closed loop 510 can provide redundancy in positioning or movement of the balancing members 135. As a result, a larger number of equilibrium states can be possible through use of a closed loop 510 of balancing members 135.

Various additional arrangements of combinations and payloads 200 and balancing members 135 can be provided.

D. The Balancing System

The balancing system 130 can actively balance the robotic system 100. In an exemplary embodiment, the balancing system 130 can be effective at balancing the robotic system 100 even while the robotic system 100 absorbs external forces, or applies forces to its environment. In an exemplary embodiment, the balancing system 130 can balance the robotic system 100 while the robotic system 100 maintains an approximately constant velocity across the surface 50. In some instances, such constant velocity can be a zero velocity. The desired velocity, as well as other instructions, can be indicated to the robotic system 100 by a control unit. The control unit can be located on the robotic system 100 or can be remote control unit. If a remote control unit is provided, such unit can communicate with the robotic system 100 via a wired or wireless connection.

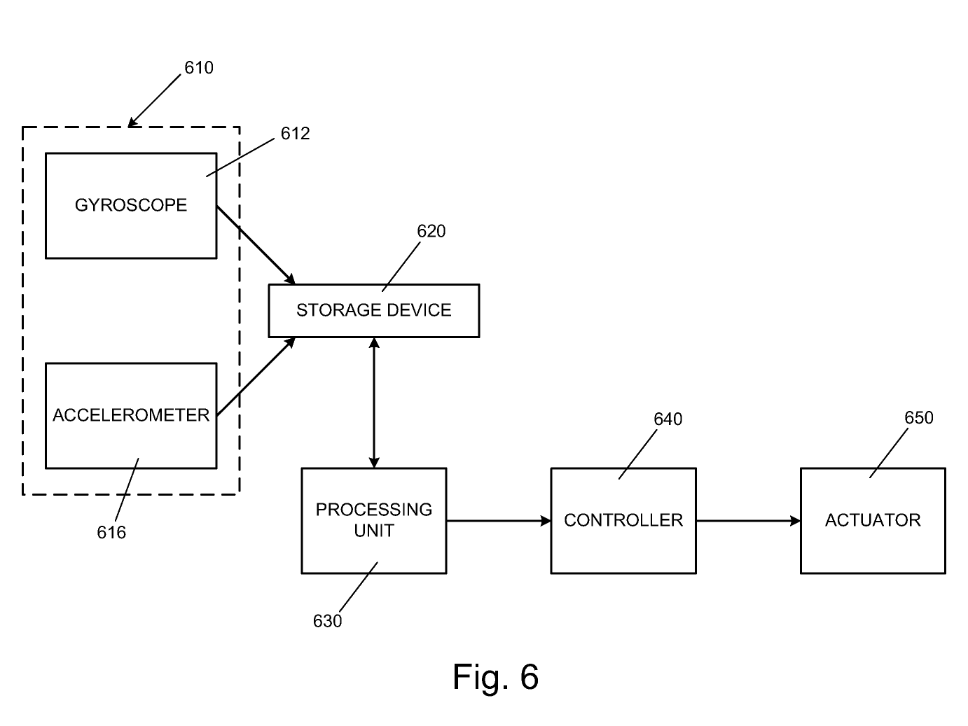

FIG. 6 illustrates a block diagram of various hardware components of the robotic system 100 that can be utilized by the balance system. As shown in FIG. 6, in addition to the components described above, the robotic system 100 can comprise a sensing system 610, at least one storage device 620, at least one processing unit 630, a set of controllers 640, and a set of actuators 650 for controlling various joints of the robotic system 100.

The sensing system 610 can include one or more components for sensing indicia of a posture of the robotic system 100. For example, in an exemplary embodiment, the sensing system 610 can include a gyroscope 612 and an accelerometer 616, either or both of which can be housed in the base 115. The gyroscope 612 can sense an angular velocity of a local portion of the robotic system 100, such as the base 115. More specifically, the gyroscope 612 can sense velocities in the roll, tilt, and yaw of the base 115, or other local portion of the robotic system 100. The accelerometer 616 can sense accelerations, such as the force of gravity, acting on the base 115. Detection of the force of gravity can indicate the pitch of the base 115. The various data detected by the sensing system 610 can be stored, at least temporarily, in the storage device 620.

The processing unit 630 can process the acceleration and angular velocity data to determine a pitch of the base 110 as well as a velocity at which the pitch is changing. This information can be used to determine the center of mass of the robotic system 100 and to predict future movement of the base 110 of the robotic system 100. Additionally, this information can be used in determining how to balance the robotic system 100. For example, the processing unit 630 can use the pitch information to instruct one or more controllers 640 to actuate joints 150 corresponding to the controllers. As a result of joint 150 movement, the balancing members 135 can be accelerated or repositioned to balance the robotic system 100.

Using the above components, embodiments of the robotic system 100 can achieve balance more effectively than previous systems and devices by implementing one or multiple balancing techniques. Each balancing technique can be provided by a sub-system of the balancing system 130. Sub-systems of the balancing system 130 can include a repositioning system 170, an accelerating system 180, and a driving system 190.

1. The Repositioning System

The repositioning system 170 can balance the robotic system 100 by repositioning various components of the robotic system 100 to move the center of mass to the target line or target point. Such repositionable components can include, for example, the base 115, the torso 118, the whole body 110, and the balancing members 135. As the robotic system 100 moves, or as an external force is applied to the robotic system 100, the center of mass may change from a stabilized state to an unstabilized state. Various components of the robotic system 100 are repositionable to restabilize the center of mass. Repositioning can be performed repeatedly in a control loop to retain balance of the robotic system 100.

Each of the balancing members 135 of the robotic system 100 can be a rigid, i.e., non-flexible, component having a determinable mass. In some instances, a balancing member 135 will have a predetermined, known mass. In other instances, however, a balancing member 135 can have an initially unknown mass. If this is the case, the mass of such a balancing member 135 can be determined based on a force the balancing member 135 exerts on the robotic system 100. Such force can be detected, for example, by a force sensor 160. Likewise the various other components of the robotic system 100 can have known or determinable masses. As the various joints 150 and 119 of the robotic system 100 have known orientations, positions of the balancing members 135 and other components relative to the base 115, or predetermined point, can be determined. Additionally, the posture of the base 115 can be determined from the sensing system 610. As a result of this collection of known and determinable information, the center of mass of the robotic system 100 can be determined.

Various forces applied to, and by, the robotic system 100 can be considered in calculating the center of mass of the robotic system 100. For example, and not limitation, if the robotic system 100 supports a payload 200, the payload 200 is considered to be part of the robotic system 100 at least for the purpose of calculating the center of mass.

Additionally, the repositioning system 170 can take into account anticipated forces, such as those that will be applied by the robotic system 100. For example, if the robotic system 100 is instructed to push on a table or pull a door, such actions can be anticipated. If a force is to be applied, such force can be anticipated by the balancing system 130. Accordingly, the robotic system 100 can prepare for such a force by repositioning one or more components of the robotic system 100 to brace for the anticipated force. In various situations, a human might crouch down before pulling a heavy box to give himself the space to create a large lever arm. Analogously, the robotic system 100 can reposition the various components in such a way that the robotic system 100 can prepare to receive or apply the anticipated force.

The repositioning system 170 can determine the current or anticipated center of mass of the robotic system 100. The repositioning system 170 can also determine the target line or point to which the center of mass should be repositioned. The repositioning system 170 can then determine how to reposition one or more individual components, such as a balancing member 135, to relocate the center of mass to the target line or point.

In some simple embodiments of the repositioning system 170, a brute force method of determining how to reposition the various components can be applied. In a brute force method, a sampling of a partial or full set of possible balancing member 135 repositionings can be simulated. After simulation of a given set of repositionings, the expected center of mass position with the given repositionings can be calculated. The best tested set of repositionings can be applied to the robotic system 100 to relocate the center of mass. Although a brute force method can be effective when applied to relatively large sampling size, such a method is unnecessarily time-consuming.

A more sophisticated method of determining desirable repositions can utilize a Jacobian matrix. From the current center of mass position and the target, which can be the target line or the target point, the repositioning system 170 can determine a velocity vector for movement of the center of mass toward the target. A matrix exists relating joint 150 manipulations to positions of various components, such as the balancing members 135. The derivative of such matrix is a Jacobian matrix relating joint 150 velocities to velocities of the various components and, therefore, to a velocity of the center of mass. A desired velocity vector for the center of mass can be determined to move the center of mass toward the target. The pseudo-inverse of the Jacobian matrix can be used to map such velocity vector to a set of velocity vectors of the various components. Accordingly, repositioning each component according to the corresponding individual velocity vector for such component can move the center of mass toward the target.

In some instances, one or more components can be given a repositioning priority over other components of the robotic system 100. For example, joints 150 and 119 associated with a first set of balancing members 135 can be required to remain fixed. For another example, joint 150 and 119 associated with a second set of balancing members 135 can be disfavored, such that such balancing members 135 are repositioned only if needed when repositioning of a third set of balancing members 135 is insufficient to balance the robotic system 100. Various combinations of repositioning priorities can be applied to the total set of repositionable components.

Implementation of such priorities can differ based on the algorithm used for determining how to reposition the components. In the case of the brute force method described above, for example, fixing selected components can be effected by eliminating select repositioning sets from the list of tested sets. In the more sophisticated method utilizing the Jacobian matrix, a selection matrix can be multiplied by the Jacobian matrix to select and deselect individual repositionable components. The selection matrix can identify a subset of components whose associated joints 150 and 119 remain fixed. Alternatively, a weighting matrix can be multiplied by the Jacobian matrix to determine a degree, or weight, to which each joint 150 or 119 is used to affect the center of mass.

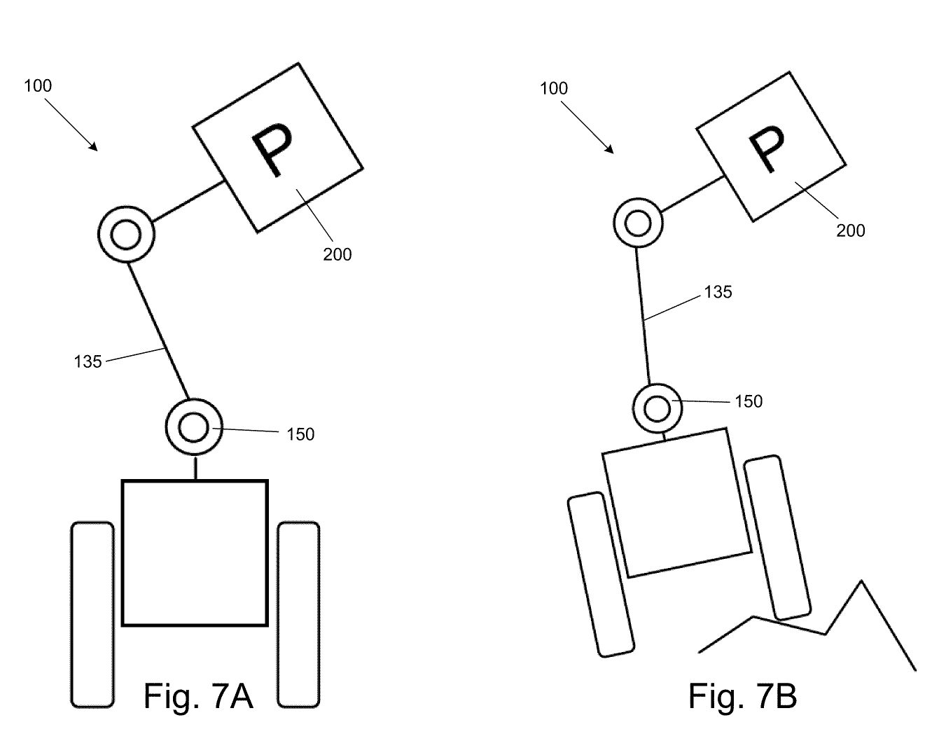

FIGS. 7A-7B illustrate an exemplary effect of the repositioning system 170. FIG. 7A depicts a state of an embodiment of the robotic system 100 positioned on a flat surface 50. FIG. 7B illustrates the same robotic system 100 when tilted by uneven terrain. As shown, the articulated arm 140 of the robotic system 100 reconfigures itself to rebalance the robotic system 100 on the uneven terrain.

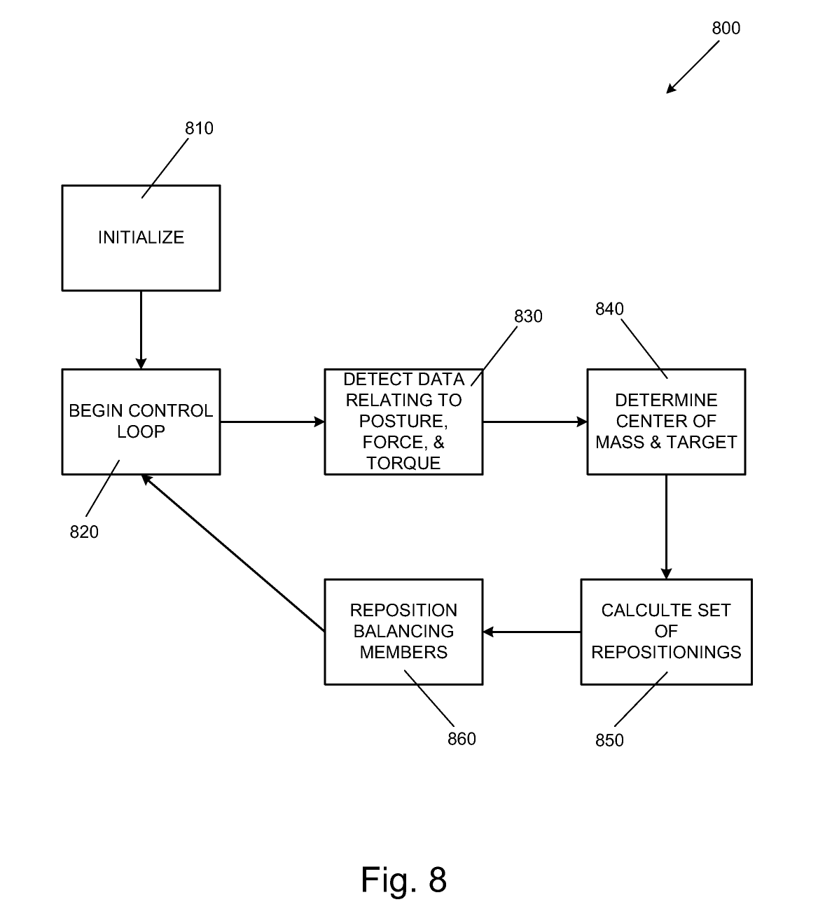

FIG. 8 illustrates a method 800 of balancing the robotic system 100 with the repositioning system 170. As shown in FIG. 8, at 810, the robotic system 100 can initialize the balancing system 130. At 820, the processing unit 630 of the robotic system 100 can enter a control loop for balancing the robotic system 100 through the repositioning system 170. Within the loop, at 830, the sensing system 610 can detect various data relating to the posture, forces, and torques of the robotic system 100. At 840, the center of mass and the target can be determined. In some instances, the target can be a target line, while in other instances, the target can be a target point. As 850, a set of repositionings can be calculated for the balancing members 135. At 860, the actuated joints 150 can reposition the balancing members 135 as calculated. The control loop can be repeated as long as it is desired to balance the robotic system 100 through the repositioning system 170.

2. The Accelerating System

The accelerating system 180 can provide balance by producing torque on the robotic system 100. Application of the accelerating system 180 is analogous to the actions of a person who throws his arms about to retain his balance. The accelerating system 180 can receive data from the sensing system 610 and various force sensors 160 regarding forces being exerted on the robotic system 100. The accelerating system 180 can also take into account anticipated forces, such as those that will be applied by the robotic system 100. For example, if the robotic system 100 is instructed to push on a table or pull a door, such actions can be anticipated. If a force is to be applied, such force can be anticipated by the balancing system 130. Accordingly, the robotic system 100 can prepare for such a force by accelerating one or more balancing members 135 to brace for application of the anticipated force.

In response to current and anticipated forces affecting the robotic system 100, the accelerating system 180 can accelerate the balancing members 135 to produce a target torque on the robotic system 100 to balance the robotic system 100. In an exemplary embodiment, the target torque is calculated to maintain or restore balance to the body 110 of the robotic system 100.

Given an equilibrium configuration q₀ of a joint 150, a torque can be applied to such joint 150 according to a control law:

τⱼ=Kₚ(Θ−Θ₀)+K_{d}(Θ^{v}−Θ^{v}₀)+Kₚ₂(q−q₀)+Kₐ₂(q^{v}−q^{v}₀),

where Θ represents an angle of the joint 150, the v-superscript represents a derivative, and initial values are represented by the 0-subscript.

The above control law can apply to torque and is equivalently written in terms of force for prismatic joints 150. Gains for individual joints 150 can be selected based on desired joint 150 motion, the configuration of the robotic system 100, and environmental factors. Specific values for gains can be determined by specifics of components used in the robotic system 100, including actuator types, system masses, and environmental conditions. Gains may also be selected in real time based on sensed data, user programmable specifications, or a combination thereof.

An intuition behind the acceleration system 180 is that an external force applied to the robotic system 100 will be reflected somewhere in the system. In other words, in response to the external force, something must accelerate. With actuated joints 150 and 119, however, the thing that accelerates need not be important to performance criteria of the robotic system 100. For example, an important criterion, such as position of a payload 200, need not be affected by the external force. Additionally, the configuration of components of the robotic system 100 can provide some redundancy, such that components can be moved toward or away from one another to achieve an approximately zero, or other target value, net torque, while retaining balance.

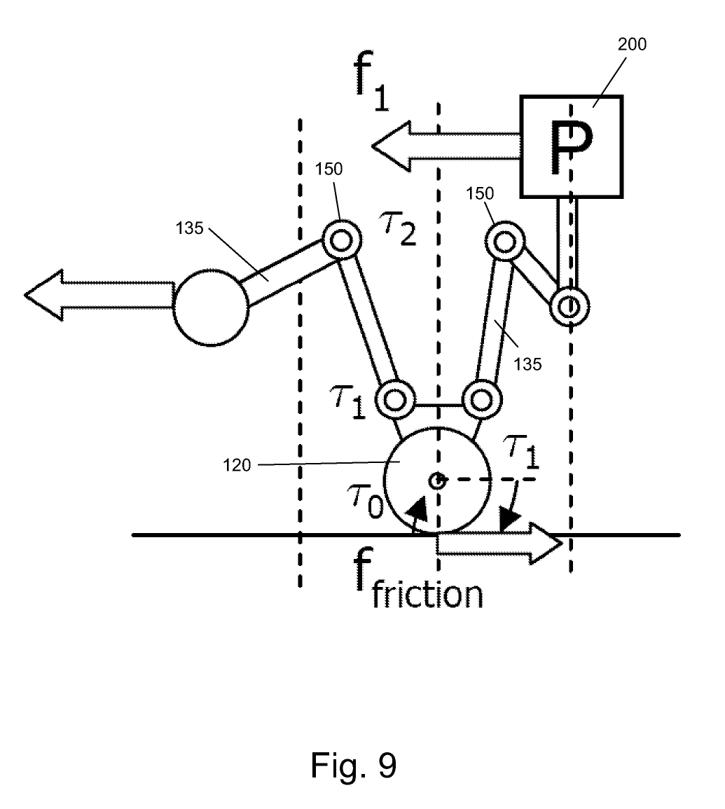

FIG. 9 illustrates the acceleration of the balancing members 130 in response to an external force, such that a payload 200 retains its position. Given the existence of a second external force, such as friction, and the ability to apply internal forces, the original external force can be balanced out by accelerating one, multiple, or all controllable system components. Such components can include, without limitation, the base 115, the torso 118, the whole body 110, and the balancing members 135. For example, as shown in FIG. 9, assuming friction f_{friction} with the ground supplies an external force, a torque τ_{w} can be applied to a wheel 125, and the two joint torques τ₁ and τ₂ can additionally be applied, such that a balancing member 135 accelerates in regard to the force f₁ applied to the payload 200. This can result in the wheel 125 and the payload 200 remaining stationary while absorbing the external force f1 by accelerating the balancing member 135.

Mathematically, assuming there exists an external force that constrains translation of the ground-contacting assembly 120, such as a friction force f_{friction}, the robotic system 100 can be represented as follows:

N q^{vv}+C=t

In the above equation, small letters represent vectors, and large letter represent matrices. Vector q is a vector of joint angles. Vector q^{vv} is a vector of joint accelerations. Matrix N is a matrix that is dependent on the current vector q, which can be estimated by a Kalman filter or other state estimator. Matrix C is a matrix that is dependent on current vectors q and qv, which represent joint positions and velocities. Finally, vector t is a vector of joint torques.

It can be assumed that the point where a helpful external force is applied is a joint 150 or 119 in the robotic system 100. For instance, in the case of friction f_{friction}, the point of applied force is the point where the ground-contacting assembly 120 touches the ground 50. It can further be assumed that q₀ is an initial angle of the relevant joint, q₁ is the angle of the wheel, and q₂ is the angle of a balancing member 135, or other component, moveable by the joint 150 or 119.

Consider a robotic system 100 having only one joint in addition to aforementioned relevant joint. Such a system 100 is depicted in FIG. 9. Define N_{AB} as the element at the A^{th} row and the B^{th} column of matrix N. Analogously, q_{A} is defined as the Ath element of vector q. Accordingly, the following can hold true:

$$[ {N}_{00} ] [ {N}_{11} ] [ {N}_{22} ] [ {C}_{0} ] [ {t}_{0} ] \\ [ {N}_{10} ] {q}_{0}^{vv} + [ {N}_{21} ] {q}_{1}^{vv} + [ {N}_{22} ] {q}_{2}^{vv} + [ {C}_{1} ] = [ {t}_{1} ] \\ [ {N}_{20} ] [ {N}_{31} ] [ {N}_{22} ] [ {C}_{2} ] [ {t}_{2} ]$$

It can be assumed that no torque exists around the 0^{th} joint (t₀=0). This is the case because there should be no actuation of a contact point of the ground-contacting assembly 120 with the ground. Furthermore, there should be no acceleration around the 0th joint (q₀^{vv}=0). Such an acceleration would indicate rolling of the wheel 125. Accordingly:

$$[ {N}_{11} ] [ {N}_{22} ] [ {C}_{0} ] [ {t}_{0} ] \\ [ {N}_{21} ] {q}_{1}^{vv} + [ {N}_{22} ] {q}_{2}^{vv} + [ {C}_{1} ] = [ {t}_{1} ] \\ [ {N}_{31} ] [ {N}_{22} ] [ {C}_{2} ] [ {t}_{2} ]$$

The above describes a system of three equations and two unknowns. Hence, a free parameter exists in the system of equations. The free parameter allows one or more torques t₁ and t₂ to be selected to achieve a particular goal, such as balancing the robotic system 100. In particular, t₁ can be chosen to satisfy the equilibrium condition in which a joint connecting the base 115 to the ground-contacting assembly 120 does not accelerate. Additionally, t₂ can be calculated to permit a selected component of the robotic system 100 to accelerate. Such selections are a matter of rearranging the equations and solving.

In circumstances where the robotic system 100 comprises multiple joints 150 and 119 and masses, a redundant system results. With regard to the equations above, in this case, t₀=0, and t₁ is a dynamic response to the applied force f₁. With such a system of multiple joints 150 and 119 and masses (i.e., moveable components), more vertical terms (i.e., equations) can be used. As a result, we can select torques in various manners, as long as t₀ and t₁ are as defined above. Methods for selecting torques to apply can be similar to the methods utilized by the repositioning system 170 to determine how to reposition components. A Jacobian matrix and its derivative, a Hamiltonian matrix, can be used to determine an overall minimum for the motion of all the components of the robotic system 100. Additionally, we can prioritize components in a similar manner as performed by the repositioning system 100. For instance, if a particular joint 150 or 119 is near its limit, then motions of other joints 150 and 119 can be prioritized over the particular joint 150 or 119.

Accelerating various components of the robotic system 100 can be performed repeatedly in a control loop to retain balance of the robotic system 100.

3. The Driving System

The driving system 190 can be similar to systems used by other balancing systems and devices. More particularly, the driving system 190 can drive the ground-contacting assembly 120 to position the center of mass to the target point, or to the target line extending vertically through the target point. Driving the contacting assembly 120 toward such target can balance the robotic system 100. Repeated calculations and movements of the ground-contacting assembly 120 can be provided in a control loop to retain balance of the robotic system 100.

Applied properly, a state estimator can reduce noisy data received from the sensing system 610. Such a state estimator can be a Kalman filter. The state estimator can be utilized to produce a relatively smooth, i.e., not noisy, prediction of the movement of the body 110. As a result, back and forth motion of the ground-contacting assembly 120 can be significantly reduced as compared to other systems and devices, even when other sub-systems of the balancing system 130 are deactivated.

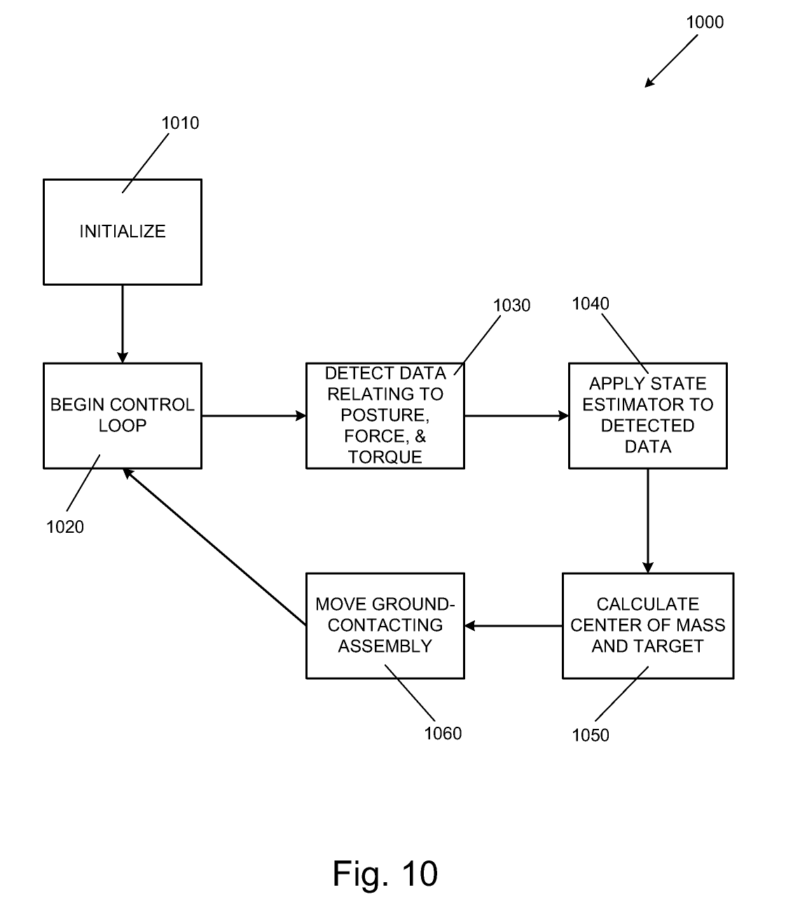

FIG. 10 illustrates a method 1000 of balancing the robotic system 100 with the driving system 190. As shown in FIG. 10, at 1010, the robotic system 100 can initialize the balancing system 130. At 1020, the processing unit 630 of the robotic system 100 can enter a control loop for balancing the robotic system 100 through the driving system 190. Within the loop, at 1030, the sensing system 610 can detect various data relating to the posture forces, and torques of the robotic system 100. At 1040, a state estimator can be applied to such data. At 1050, from the output of the state estimator, the processing unit 630 can calculate the center of mass and the target in a coordinate system relative to the robotic system 100. At 1060, the processor can direct a controller of the ground contacting assembly 120 to move the ground-contacting assembly 120 to relocate the target on, or towards, the center of mass of the robotic system 100. The control loop can be repeated as long as it is desired to balance the robotic system 100 through the driving system 190.

The sub-systems 170, 180, and 190 of the balancing system 130 can be complementary and can be applied in combination to achieve increased or customized performance. For example, if limitations exit on balancing member 135 positions, actuator torque limits, surface contact area, or a combination thereof, a specific combination and weighting of the sub-systems 170, 180, and 190 can be used.

### III. CONCLUSION

Accordingly, as described herein, embodiments of the robotic system 100 can operate effectively in uneven, unpredictable, or cluttered terrain, and when faced with or applying various forces.

While robotic systems 100 have been disclosed in exemplary forms, it will be apparent to those skilled in the art that many modifications, additions, and deletions may be made without departing from the spirit and scope of the robotic systems 100, methods, and their equivalents, as set forth in the following claims.

1. A statically unstable self-balancing robotic system comprising:
one or more balancing members; and
a balancing system for providing dynamic stability to the robotic system while the robotic system maintains an approximately constant velocity across a surface, the balancing system repeatedly repositioning at least one of the balancing members to move the center of mass of the robotic system to a target, wherein the target is selected to balance the robotic system.

2. The self-balancing robotic system of claim 1, the balancing system selecting a first subset of the balancing members for repositioning, and retaining a second subset of the balancing members at their current positions.

3. The self-balancing robotic system of claim 1, the balancing system calculating a target torque for balancing the robotic system.

4. The self-balancing robotic system of claim 3, the balancing system accelerating the balancing member to produce the target torque on the robotic system.

5. The self-balancing robotic system of claim 1, the balancing system utilizing feedback linearization to determine how to reposition the balancing members.

6. The self-balancing robotic system of claim 1, wherein the balancing system calculates how to reposition the balancing members by mapping a desired velocity vector of the center of mass of the robotic system to a set of target member velocity vectors for the balancing members.

7. (canceled)

8. The self-balancing robotic system of claim 1, the balancing system configured to prioritize repositioning of a first balancing member over repositioning of a second balancing member.

9. The self-balancing robotic system of claim 1, the balancing system applying a set of weights to the balancing members corresponding to contributions of each balancing member to repositioning of the center of mass.

10. (canceled)

11. A statically unstable self-balancing robotic system comprising:
one or more balancing members; and
a balancing system for providing dynamic stability to the robotic system while the robotic system maintains an approximately constant velocity across a surface, the balancing system repeatedly accelerating at least one of the balancing members to produce a target torque on the robotic system, wherein the target torque is calculated to balance the robotic system.

12. The self-balancing robotic system of claim 11, further comprising a wheeled ground-contacting assembly for supporting the robotic system over a surface.

13. (canceled)

14. The self-balancing robotic system of claim 12, the ground-contacting assembly comprising no more than two wheels.

15. The self-balancing robotic system of claim 12, further comprising a base, wherein the balancing system drives the ground-contacting assembly to repeatedly reposition the base under the center of mass of the robotic system.

16. (canceled)

17. (canceled)

18. The self-balancing robotic system of claim 11, further comprising a sensing system for sensing indicia of a pitch of a portion of the robotic system, the sensing system comprising at least one of the group consisting of a gyroscope and an accelerometer.

19. The self-balancing robotic system of claim 11, further comprising a force sensor for sensing an external force applied to the robotic system, wherein the balancing system is configured to produce an equal and opposite force of the external force to retain balance of the robotic system.

20. (canceled)

21. The self-balancing robotic system of claim 11, wherein the approximately constant velocity of the robotic system across the surface has a magnitude of approximately zero.

22. The self-balancing robotic system of claim 11, the approximately constant velocity of the robotic system being selectable by a user.

23. (canceled)

24. The self-balancing robotic system of claim 11, the balancing members being arranged in serial and connected together by arm joints to form an articulated arm.

25. (canceled)

26. The self-balancing robotic system of claim 11, the balancing members being controllable by two or more actuators.

27. (canceled)

28. (canceled)

29. The self-balancing robotic system of claim 11, further comprising a body from which at least one of the balancing members extends, the body comprising:
a base;
a torso; and
a waist joint coupled to a waist actuator, the waist joint moveably attaching the torso to the base of the body.

30. (canceled)

31. (canceled)

32. A statically unstable robotic system having a constant velocity, the robotic system comprising:
one or more balancing members;
a first state in which the center of mass of the robotic system is stable;
a second state in which the center of mass of the robotic system is unstable, wherein stability is restored to the center of mass by moving the center of mass to a target.

33-47. (canceled)
